(19) United States
(12) Patent Application Publication
(10) Pub. No.: US 2026/0327093 A1
(43) Pub. Date: Oct. 22, 2026

(54) WATER PURIFICATION SYSTEM

(71) Applicant: Kaustubh CHILWARWAR, Plantation, FL (US)

(72) Inventor: Kaustubh CHILWARWAR, Plantation, FL (US)

(21) Appl. No.: 19/350,017

(22) Filed: Oct. 5, 2025

(30) Foreign Application Priority Data
Apr. 17, 2025 (IN) 202521037355

(51) Int. Cl. C02F 1/00

(52) U.S. Cl. CPC C02F 1/001; C02F 2201/007; C02F 2209/40; C02F 2301/06

(57) ABSTRACT

The present invention relates to a water purification system (100). The system (100) includes an inlet chamber (101) configured to receive an input water stream (160). A purification module (102) fluidly coupled to the inlet chamber (101). A purified water outlet (106) fluidly coupled to the purified water stream (104). An impure water outlet (107) fluidly coupled to the impure water stream (105). Also, at least one hydrophilic surface disposed within the purification chamber (103) the hydrophilic surface cooperating with a purified outlet wall (113) defining a plurality of micro-capillaries. Each micro-capillary (90) has a non-circular cross-sectional geometry. The hydrophilic surface (60) and micro-capillaries (90) are configured to facilitate passive water conduction without requiring applied external pressure.

### FIELD OF THE INVENTION

The present invention relates to a water purification system. More specifically, the present invention relates to a hydrophilicity-based water purification system.

### BACKGROUND OF THE INVENTION

Generally, the cleaning of water is very important for human and animal health. Multiple sectors such as manufacturing, farming, tourism, recreation, energy production, and other economic sectors require clean water to function effectively and efficiently.

In the current scenario, the cleaning of water is technologically challenging. Presently, there are two major technologies to purify water: reverse osmosis (RO) and distillation. Both these technologies suffer from numerous drawbacks. An important drawback of each of these technologies is that they consume large amounts of energy.

For instance, saltwater reverse osmosis-converting saltwater into freshwater, also known as desalination-consumes an average of 10-13 kilowatt hours (kwh) per every thousand gallons. Theoretically, distillation requires a minimum energy of 2594 kJ for cleaning 1 litre of water, which is roughly 2700 kwh per 1000 gallons. Thus, both technologies are highly energy intensive. In addition, these technologies are not readily scalable.

Also, increasing population increases the demand for potable water, both for individual use and for various industrial and commercial uses, such as foods, drinks, and alcohol. The increasing demand for potable water increases the amount of energy needed to purify water. Energy sources to meet the energy demands to purify water, such as electricity and fuels, have huge environmental impacts. At times, the energy demands cannot be met and droughts occur.

Additionally, the conventional water purification systems are not entirely satisfactory for a variety of reasons. The existing water purification systems are energy intensive and expensive to operate. Also, the conventional water purification systems are complicated and difficult to scale. Third, maintenance and operating procedures are also undesirably involved with currently known water purification systems.

Further, the existing hydrophilic surfaces do not produce very wide exclusion zones which limits the effective flow rate significantly. The capillaries for pure water conduction are circular and hence not very effective for conducting the water. As the water in exclusion zone is more viscous than regular water, which decreases the flow rate, hence the diameter of the circular capillaries has to be bigger in size to increase the flow rate. However, the exclusion zones produced by the defined hydrophilic surfaces are not wide, so the increase in diameter will eventually exhaust the exclusion zones before they are formed again. Thus, the volumetric efficiency with current materials will be very low.

Furthermore, in the existing system, the pure water collection side doesn't have the same hydrophilic coating in its channels as the hydrophilic plates, which needs an external pressure to overcome the barrier for the flow.

Therefore, there is a need for a water purification system and method for generating electrical energy from a volume of water which overcomes one or more drawbacks of the above-mentioned prior art.

### OBJECTS OF THE INVENTION

An object of the present invention is to provide a water purification system.

Another object of the present invention is to provide a water purification system, having reduced green-house gas emissions.

One more object of the present invention is to provide a water purification system, which is easy to maintain.

Yet another object of the present invention is to provide a water purification system, which is cost effective.

Still one more object of the present invention is to provide a water purification system, which is simple in operation.

### SUMMARY OF THE INVENTION

According to the present invention a water purification system is provided. The system includes an inlet chamber, a purification module, a purified water outlet, an impure water outlet, and at least one hydrophilic surface. The inlet chamber is configured to receive an input water stream. The purification module is fluidly coupled to the inlet chamber. The purification module includes a purification chamber which is configured to divide the input water stream into a purified water stream and an impure water stream. The purified water outlet is fluidly coupled to the purified water stream. Specifically, the purification module is manufactured using a process selected from the group consisting of a 3D printing, an injection molding, an anodic bonding of pre-formed glass structures or a microelectronic adhesive bonding. The impure water outlet is fluidly coupled to the impure water stream.

The at least one hydrophilic surface disposed within the purification chamber. The hydrophilic surface is cooperating with a purified water outlet wall defining a plurality of micro-capillaries. In an aspect of the present invention, the purified outlet wall is coated with the same hydrophilic material as the hydrophilic surfaces in the purification chamber to ensure continuous hydrophilic interaction along the water conduction pathway. Also, the purified water outlet wall and the impure water outlet wall are placed parallel each other and have striations to allow the hydrophilic surface to slide. The vertical striations on the purified wall and the impure wall are configured in such a way that the hydrophilic surfaces are parallel to each other after sliding therein. The vertical striations are etched at equal distances to keep the volume of each purification chamber constant or may be etched at different distances if variation in volume is required across each purification chamber. Each micro-capillary has a non-circular cross-sectional geometry which is selected from the group consisting of triangular, trapezoidal, hexagonal, rectangular, rhomboidal, or curved geometries with a smaller cross-section at the bottom than at the top. Specifically, the microcapillaries are created by a wet etching process resulting in an increasing cross-section and thus facilitating unidirectional flow of purified water in the direction of increasing cross-section thereby further enhancing the efficacy of water conduction in tandem with a non-circular cross-sectional geometry.

The hydrophilic surface and micro-capillaries are configured to facilitate passive water conduction without requiring applied external pressure. In an aspect of the invention, the hydrophilic surface is formed using a material selected from the group consisting of a silicon-based hydrophilic coatings, a metal oxide coating, a polymer-based hydrophilic layers, a bio-inspired coatings, or an atomic layer deposition (ALD) coating.

The silicon based hydrophilic coating includes at least one of a starch-coated silicon surface, a mica-coated silicon surface, a silica (SiO₂) nano-structured coating, or a silicon hydroxylation treatment. Additionally, the polymer-based hydrophilic layer includes at least one of a polyvinyl alcohol (PVA) coating, a polyethylene glycol (PEG) coating, or a polydopamine (PDA) coating.

Further, the metal oxide coating includes at least one of a titanium dioxide (TiO₂) coating, an indium tin oxide (ITO) coating, or an electrochemically anodized oxide layer. Furthermore, the bio-inspired hydrophilic coating includes at least one of a phosphorylcholine (PC)-based polymer, a metal-organic framework (MOF) film, or a graphene oxide (GO) functionalized surface.

### BRIEF DESCRIPTION OF DRAWINGS

The advantages and features of the present invention will be understood better with reference to the following detailed description and claims taken in conjunction with the accompanying drawings, wherein like elements are identified with like symbols, and in which:

FIG. 1 illustrates a perspective view of water purification system;

FIG. 2 illustrates an exploded view of the water purification system shown in FIG. 1;

FIG. 3 illustrates a top perspective view of the water purification system shown in FIG. 1 with an inlet chamber removed to depict a plurality of purification chambers;

FIG. 4 illustrates a right-side elevation view of one of the purification chambers;

FIG. 5 illustrates a top plan view of the inlet chamber showing internal flow control chambers and floor ports;

FIG. 6 illustrates front a side elevation view of the water purification system shown in FIG. 1;

FIG. 7 illustrates a rear side elevation view of the water purification system shown in FIG. 1;

FIG. 8 illustrates a cross-section view of a chamber wall depicting a substrate with left and right faces each having an activated carbon sphere coating;

FIG. 9 illustrates a cross-section view of a chamber wall depicting a substrate with left and right faces that have been autoclaved to make them hydrophilic;

FIG. 10 illustrates a schematic view of micro-capillaries;

FIG. 11 illustrates a wet etching process for creating micro-capillaries; and

FIG. 12 illustrates a fabrication process of micro-capillaries using deep reactive ion-etching (DRIE); and

FIG. 13 illustrates a perspective view of a hydrophilic surface between the purified outlet wall and the impure outlet wall.

### DETAILED DESCRIPTION OF THE INVENTION

An embodiment of this invention, illustrating its features, will now be described in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The present invention relates to a water purification system. The water purification system describes about purifying a stream of water using hydrophilic surface. The system allow water to spread evenly across a filter, maximizing contact with purification materials and improving efficiency in removing pollutants. The system has reduced greenhouse gas emissions. The system is simple in operation.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items.

The disclosed embodiments are merely exemplary of the invention, which may be embodied in various forms.

While specific embodiments of the present invention are described herein, it should be understood that various modifications, adaptations, and alternative implementations are possible without departing from the spirit and scope of the invention. The invention is not limited to the precise form factors, dimensions, materials, or fabrication techniques described, and may be adapted for different applications as required.

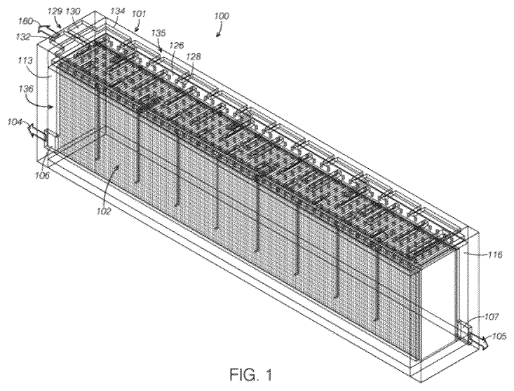

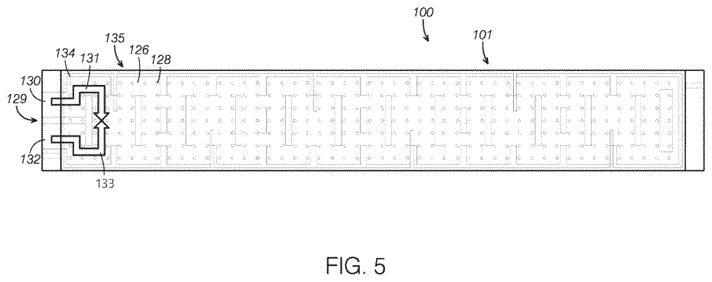

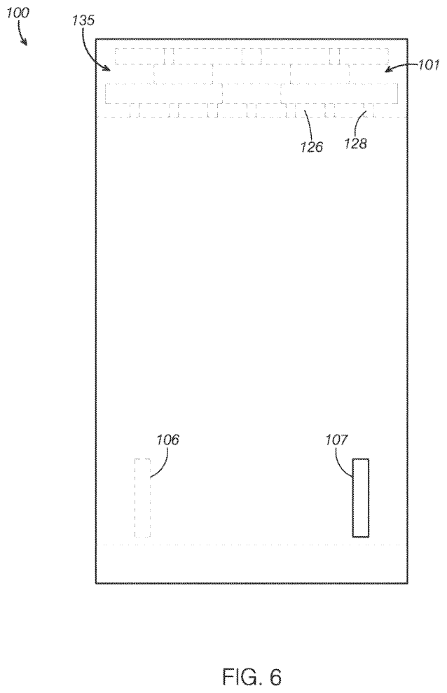

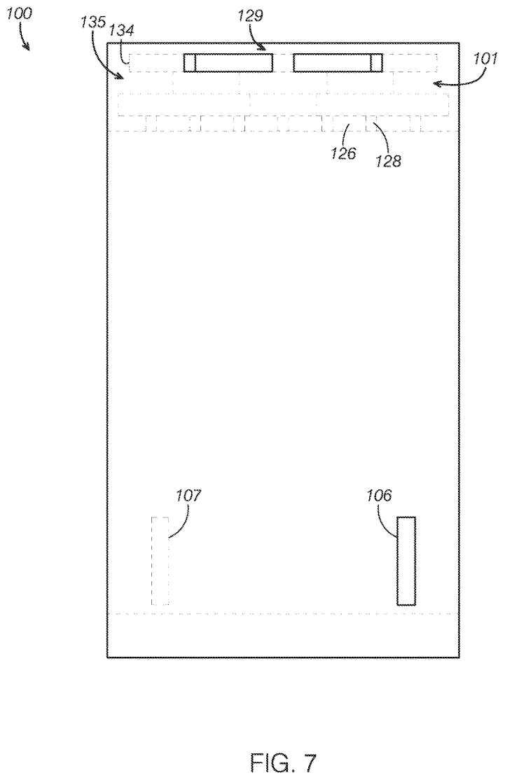

Referring now to FIGS. 1 to 8, a water purification system (100) in accordance with the present invention is illustrated. The water purification system (100) herein after referred as “The system (100)”. The system (100) includes an inlet chamber (101), a purification module (102), a purified water outlet (106), an impure water outlet (107). The inlet chamber (101) is configured to receive the input water stream (160). The inlet chamber (101) includes a primary inlet (129) which allows the input water stream (160) to pass through the inlet chamber (101). The inlet chamber (101) is configured to control the flow characteristics of input water stream (160). Specifically, in the present embodiment, the inlet chamber (101) includes a plurality of flow control chambers (135) downstream of primary inlet (129). The plurality of flow control chambers (129) includes a flow control chamber (135) (as shown in FIGS. 1, 2 and 5).

Also, in the present embodiment, the inlet chamber (101) is configured to deliver input water stream (160) to purification module (102). The inlet chamber (101) includes a floor (126) proximate to the purification module (102) with a plurality of floor ports (128) providing a fluid communication path from inlet chamber (101) to the purification module (102). In the present embodiment, the inlet chamber (101) is disposed on the purification module (102) (as shown in FIGS. 1, 2, 5 and 7). It is obvious to a person skilled in the art to configure the inlet chamber (101) of any geometry (shape and size).

Further, the primary inlet (129) allows the input water stream (160) to the inlet chamber (101). The primary inlet (129) includes a first sub inlet (130) through which a first portion (131) of input water stream (160) enters inlet chamber (101). Also, the primary inlet (129) includes a second sub inlet (132) through which a second portion (133) of input water stream (160) enters inlet chamber (101). It is obvious to a person skilled in the art to configure the primary inlet (129) of any geometry (shape and size) but not limited to circle, oval, triangle, square, rectangle pentagon, and the like. Alternatively, the shape of the primary inlet (129) may be a sphere, a pyramid, a cone, a cube, and variations thereof, such as a hemisphere or a frustoconical shape and the like.

Also, the flow control chamber (134) functions to control the flow characteristics of input water stream (160). The flow control chambers (134) cause input water stream (160) to flow laminarly in inlet chamber (101) (as shown in FIGS. 1, 2 and 5). The flow control chamber (134) defines flow channels directing first portion (131) of input water stream (160) to collide head-on with second portion (133) of input water stream (160) to offset the flow energies of the first portion (131) and the second portion (133). Specifically, the floor (126) is configured to direct input water stream (12) through inlet chamber (101). The floor (126) is fluidly coupled to the inlet chamber (101) with the purification module (102). The floor (126) defines plurality of floor ports (128) extending through floor (126). The plurality of floor ports (128) is fluidly coupled to the inlet chamber (101) with the purification module (102), including with purification chamber (136) (as shown in FIGS. 1, 2, 5 and 7). It is obvious to a person skilled in the art to configure the floor (126) of any geometry (shape and size).

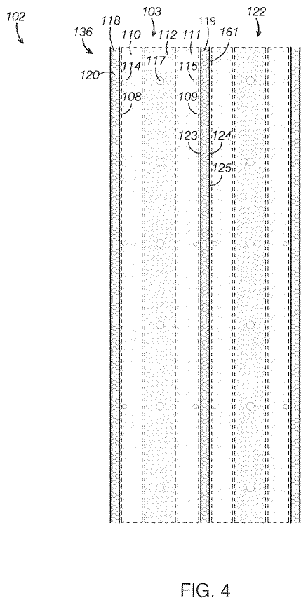

Furthermore, the purification module (102) is fluidly coupled to the inlet chamber (101). The purification module (102) is manufactured using a process selected from the group consisting of 3D printing, an injection molding, an anodic bonding of pre-formed glass structures, a microelectronic adhesive bonding. The purification module (102) including a purification chamber (103) configured to divide input water stream (160) into a purified water stream (104) and an impure water stream (105). The purification module (102) has plurality of purification chambers (136), including purification chamber (103) and adjacent purification chamber (122) (as shown in FIGS. 1, 3 and 4). Each purification chamber (103) in the plurality of purification chambers (136), including purification chamber (103) and adjacent purification chamber (122), is configured to divide a portion of input water stream (160) into purified water stream (104) and impure water stream (105). Each of the purification chambers (103) in plurality of purification chambers (136) is substantially identical to the purification chamber (103) (as shown in FIG. 4). It is obvious to a person skilled in the art to configure the purification module (102) of any geometry (shape and size) such as sphere, a pyramid, a cone, a cube, and variations thereof, such as a hemisphere or a frustoconical shape and the like. Specifically, in the present embodiment, the adjacent purification chamber (122) shares a second chamber wall (119) with the purification chamber (103).

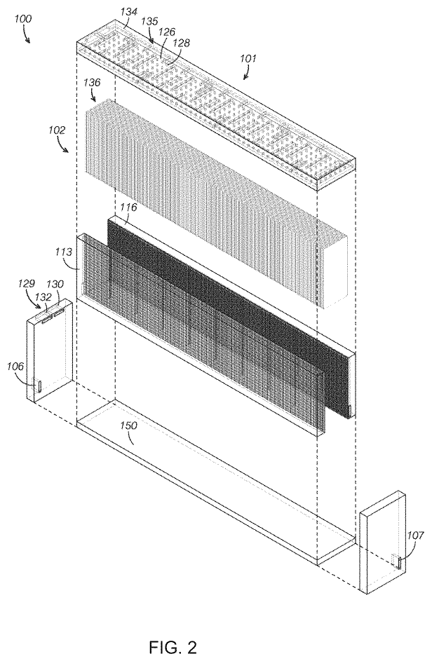

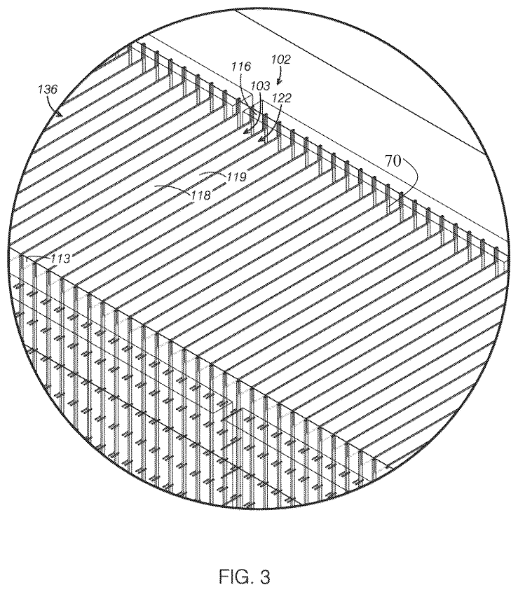

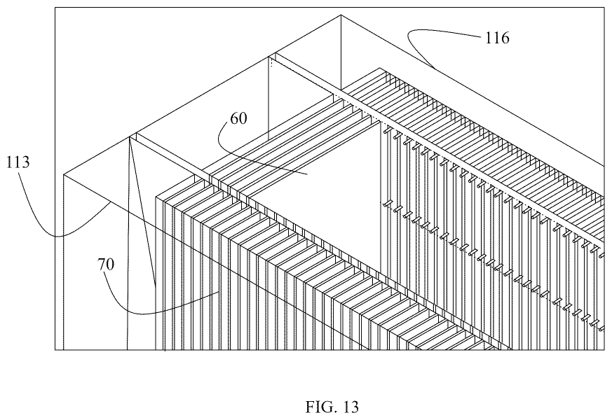

The purification chamber (103) includes a first chamber wall (118), a second chamber wall (119), a purified outlet wall (113), and an impure outlet wall (116) collectively defining the lateral boundaries of purification chamber (103). The longitudinal boundaries of purification chamber (103) are defined by floor (126) to the top of purification chamber (103) and a tray (150) disposed on the bottom of purification chamber (103) (as shown in FIGS. 3 and 4). Specifically, the second chamber wall (119) is spaced from first chamber wall (118). The purified outlet wall (113) and impure outlet wall (116) is extended between first chamber wall (118) and second chamber wall (119) (as shown in FIGS. 2 and 3). The impure outlet wall (116) is spaced from purified outlet wall (113). Specifically, the impure outlet wall (116) and the purified outlet wall (113) are placed parallel to each other. Also, the impure outlet wall (116) and the purified outlet wall (113) have striations (70) (long slots) to allow the hydrophilic surfaces to slide in. Specifically, the vertical striations (70) on the purified outlet wall (113) and the impure outlet wall (116) are configured in such a way that the hydrophilic surfaces are parallel to each other after sliding therein. Also, the vertical striation (70) holds the hydrophilic surface in place during transport and operation (as shown in FIG. 13). The vertical striations (70) are etched at equal distances to keep the volume of each purification chamber (103) constant or maybe etched at different distances if variation in volume is required across each purification chamber (103).

The location of the port relative to the purified water zones and the impure water zone, purified outlet wall (113) is depicted transparently closest to the viewing plane of the page and impure outlet wall (116) is depicted transparently into the page beyond the viewing plane of the page (as shown in FIG. 4).

The purification chamber (103) configured to establish distinct zones of water within the purification chamber (103). The distinct zones are two purified water zones and the second zone has an impure water zone. It is obvious to a person skilled in the art to configure as many number of the purification chambers which are necessary for the purification of the water. The purification chamber (103) establishes a first purified zone (110) which has substantially pure water proximate to the first chamber wall (118) and a second purified zone (111) which has substantially pure water proximate to the second chamber wall (119). An impure zone (112) of impurity concentrated water is disposed between the first purified zone (110) and second purified zone (111). Specifically, the purified water stream (104) is supplied by substantially pure water from the first purified zone (110) and second purified zone (111). The impure water stream (105) is supplied by the impurity concentrated water from the impure zone (112) (as shown in the FIG. 4). It is obvious to a person skilled in the art to configure the purification chamber (103) of any geometry (shape and size).

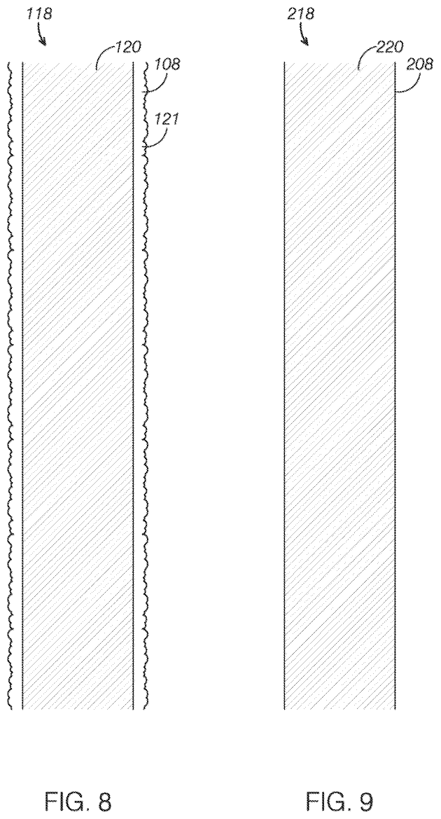

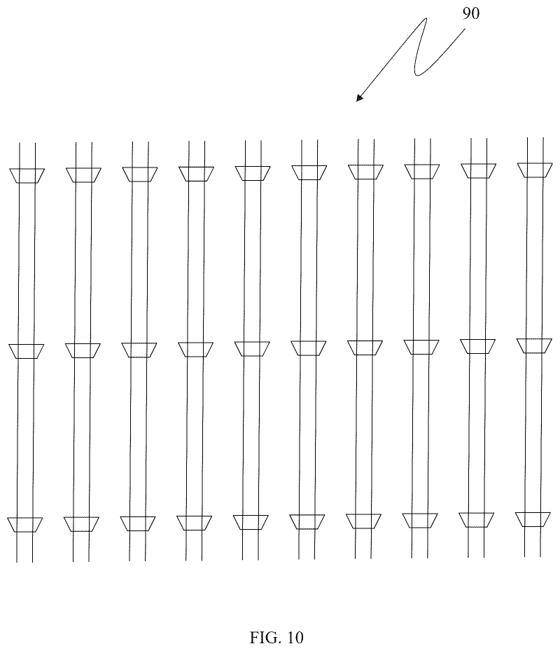

Referring again FIGS. 4 and 8, at least one hydrophilic surface is disposed within the purification chamber (103). The hydrophilic surface cooperates with the purified outlet wall (113) defining a plurality of micro-capillaries (90). In the present embodiment, each micro-capillary (90) has a non-circular cross-sectional geometry which is selected from the group of polygons such as triangular, trapezoidal, hexagonal, rectangular, rhomboidal, or curved geometries with a smaller cross-section at the bottom than at the top. It is obvious to a person skilled in the art to configure the micro-capillaries (90) in the triangular, the rectangular, the hexagonal geometries as the triangular, the rectangular, the hexagonal geometries to increase volumetric efficiency and flow rate of purified water conducted from exclusion zones (EZs) without the need for applied external pressure. The hydrophilic surface may be formed on one or more chamber walls, such as a first chamber wall (118) and a second chamber wall (119).

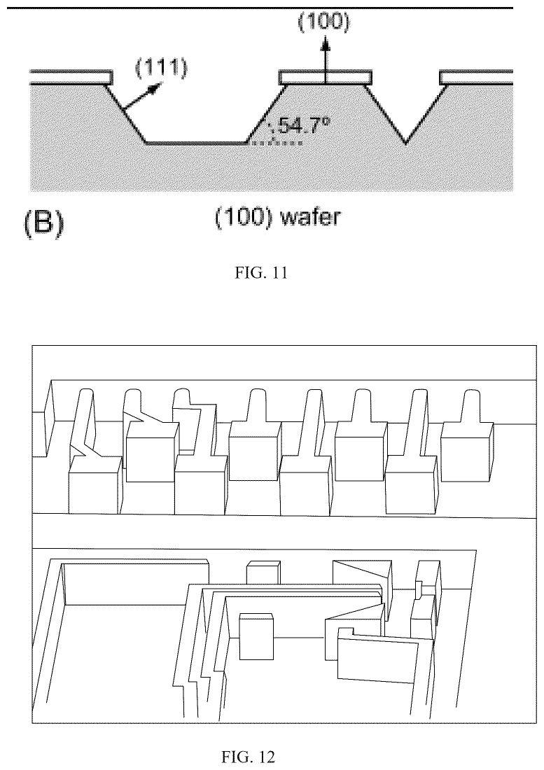

The hydrophilic surfaces (60) and the micro-capillaries (90) are further treated or coated to improve the hydrophilicity. The hydrophilic surface (60) and the micro-capillaries (90) are configured to facilitate passive water conduction without requiring applied external pressure. Also, the micro-capillaries (90) may be created using a laser micro-machining or a deep reactive ion-etching (DRIE). Specifically, deep reactive ion-etching (DRIE) is used for treating the microcapillaries as it produces straight face etches with high aspect ratio. The features produced during the deep reactive ion-etching (DRIE) process is shown in FIG. 12. It is obvious to a person skilled in the art to use any method for creating micro-capillaries but not limited to deep reactive ion-etching (DRIE) and laser micro-machining. Alternatively, the micro capillaries are created using a wet etching process with KOH solution. The wet etching process is used with (1 0 0) top crystal orientation (as shown in FIG. 11) when silicon is used as a substrate. Specifically, the wet-etching process produces micro-capillaries (90) with increasing cross-section and thus facilitating unidirectional flow of purified water in the direction of increasing cross-section, thereby further enhancing the efficacy of water conduction in tandem with a non-circular cross-sectional geometry.

In various embodiments, the hydrophilic coating may be applied to both the interior surfaces of the purification chamber and the internal surfaces of the micro-capillaries, enabling water flow along the conduction path. In the present embodiment, the hydrophilic surface (60) is formed by using a material selected from the group of a silicon-based hydrophilic coating, a metal oxide coating, a polymer-based hydrophilic layers, a bio-inspired coatings, or an atomic layer deposition (ALD) coating.

In an embodiment, the silicon based hydrophilic coating includes at least one of a starch-coated silicon surface. The starch coated silicon surface is fabricated as follows:

A silicon wafer is thoroughly cleaned using an RCA cleaning process and rinsed with distilled water and dried with nitrogen gas. A diluted solution of a silane coupling agent is prepared by mixing it with an appropriate solvent (preferably 1-2% silane in ethanol) and the solution is stirred well to ensure uniformity.

The silicon wafer is immersed in the silane solution or the silicon wafer is applied using a pipette to ensure all the patterned and the non-patterned surfaces are fully covered and the silane is allowed to react with the wafer surface for 10-15 minutes to form a uniform layer. The silicon wafer is rinsed with ethanol or isopropanol to remove excess silane and the wafer is dried using nitrogen gas or by placing it on a hot plate at 60° C. for 5-10 minutes.

A homogeneous starch solution is prepared by dissolving starch in distilled water with gentle heating and stirring. The homogeneous solution is gently heated while stirring until fully dissolved, and then cooled to room temperature. The solution is filtered through a 0.2-micron filter to remove any undissolved particles.

The silicon wafer is immersed in the starch solution and placed under vacuum to remove trapped air and ensure uniform infiltration. Specifically, the silicon wafer is placed in a petri dish. The starch solution is gradually introduced into the petri-dish using a pipette or syringe until the wafer is fully immersed in the starch solution. The petri dish in a vacuum chamber is placed to ensure any air bubbles are removed and the solution contacts all the surfaces. In a mass manufacturing setting, the same process may be facilitated by immersing multiple substrate wafer in the starch solution and placed in vacuum or ultrasonic bath to remove air bubbles and ensure uniform infiltration.

The coated wafer is dried at 60-80° C. to solidify the starch layer. The wafer is carefully removed and placed on a level surface. The wafer is heated on a hot plate or in an oven at 60-80° C. to evaporate water and solidify or dry the starch. The infiltration and drying process may be repeated to achieve the desired thickness.

In another embodiment, the silicon-based hydrophilic coating includes a mica-coated silicon surface. The process for forming the mica-coated silicon surface includes the following steps:

The silicon wafer substrate undergoes a rigorous cleaning protocol. It is first cleaned using solvents such as acetone and isopropyl alcohol (IPA), followed by rinsing with deionized water to remove contaminants. To further enhance surface hydrophilicity, the substrate maybe treated with oxygen plasma.

A 5M solution of potassium silicate or potassium hexafluorosilicate (K₂SiF₆) is prepared with muscovite mica precursors. The solution is prepared as follows:

Potassium silicate is selected for its silica content, whereas K₂SiF₆ is used as a precursor to enhance fluorosilicate properties, both contributing to mica formation. The chosen precursor is mixed with deionized water to achieve the desired concentration, around 5 molarity to ensure complete dissolution.

Muscovite mica powder is incorporated into the solution while maintaining consistent stirring to facilitate even dispersion. If necessary, the pH is adjusted to a neutral range to optimize conditions for mica crystallization.

The cleaned silicon substrate is immersed into the prepared solution and placed in an autoclave. This promotes mica crystal growth on the silicon surface at controlled high temperatures (250° C.) and pressure. The mica layers are allowed to grow over several hours (24 hours), ensuring a uniform deposition in both flat and patterned areas. After the deposition process, the substrate is rinsed with deionized water to remove residual chemicals and dried using nitrogen.

The coated substrate is then subjected to a thermal treatment at approximately 400° C. in an inert atmosphere to crystallize and strengthen the mica layer. The resulting mica-coated surface exhibits very wide exclusion zones, significantly enhancing its hydrophilic properties.

In yet another embodiment, the silicon-based hydrophilic coating includes a silica (SiO₂) nano-structured coating. The process for forming the silica (SiO₂) nano-structured coating comprises the following steps:

A sol-gel is used to prepare a mixture of tetraethyl orthosilicate (TEOS) and ethanol.

The prepared sol-gel mixture is applied to the silicon substrate using either a dip-coating or spray-coating technique.

The coated substrate is baked at a temperature range of 250° C. to 400° C. for approximately 1 hour to facilitate curing. Alternatively, wet oxidation may be performed to coat the silicon surface with SiO₂.

In one more embodiment, the silicon-based hydrophilic coating includes a silicon hydroxylation treatment. The silicon hydroxylation treatment method includes the following steps:

The silicon substrate is immersed in piranha solution (a 3:1 mixture of H₂SO₄ and H₂O₂) for approximately 10-15 minutes to remove organic contaminant and rinsed thoroughly with deionized (DI) water.

The cleaned substrate is soaked in a solution of 1:1:5 HCl:H₂O₂: DI water at 80° C. for 10-15 minutes to introduce a surface hydroxyl group and rinsed again with DI water to remove residual chemicals.

The substrate is blow dried with nitrogen gas or spin-dried using a spin coater. Alternatively, the substrate may be baked at a temperature of 100-120° C. for approximately 10-15 minutes.

The substrate is immersed in DI water at elevated temperatures (e.g., 80° C.) for an additional 10-15 minutes for final hydroxylation to ensure a dense, and a uniform Si—OH layer.

Further, the metal oxide coating includes at least one of a titanium dioxide (TiO₂) coating, an indium tin oxide (ITO) coating, or an electrochemically anodized oxide layer. In an embodiment, the titanium dioxide (TiO₂) coating is formed through the following steps:

A TiO₂ precursor solution is prepared using sol-gel synthesis. The precursor solution is applied onto the substrate either using a spin-coating method or a dip-coating method. The coated substrate is heated at 450-500° C. in a furnace for crystallization and curing.

Alternatively, the substrate maybe sputtered with a thin layer of titanium (Ti), and then oxidized to form a uniform layer of TiO₂ on the surface.

In another embodiment, the metal oxide coating includes a Conductive Indium Tin Oxide (ITO) Coating with Surface Oxygenation. The coating process comprises the following steps:

The substrate surface is coated with Indium Tin Oxide (ITO) and subsequently exposed to oxygen plasma to induce high hydroxylation.

The treated conductive surface assists in water structuring via charge-assisted exclusion zone (EZ) formation.

Furthermore, the polymer based hydrophilic layer includes at least one of a polyvinyl alcohol (PVA) coating, a polyethylene glycol (PEG) coating, or a polydopamine (PDA) coating. In one embodiment, the polyvinyl alcohol (PVA) coating is formed through the following steps:

Polyvinyl alcohol (PVA) coating is dissolved in water at 80° C. with continuous stirring. The PVA solution is applied to the substrate using a dip-coating or spray-coating method to ensure uniform deposition.

The coated substrate is dried in an oven at 50-70° C. for 1-2 hours for curing.

In one more embodiment, the polymer based hydrophilic layer includes a polyethylene glycol (PEG) coating, the polyethylene glycol (PEG) coating is formed through the following steps:

A polyethylene glycol (PEG)-silane solution is prepared in ethanol. The silicon substrate is dipped in the solution for 30 minutes at room temperature. The coated substrate is heated at 100-120° C. for 1 hour to bond PEG to the surface for curing.

In yet another embodiment, the polymer based hydrophilic layer includes a polydopamine (PDA) coating, the polydopamine (PDA) coating is formed through the following steps:

The substrate surface is coated with polydopamine (PDA) followed by a cross-linked hydrogel network (e.g., polyvinyl alcohol or polyacrylic acid).

Water-retaining hydrogel enhances exclusion zone (EZ) width by continuously supplying structured water, thereby improving hydrophilic properties.

Moreover, the bio-inspired coating with hydrogel networks includes at least one of a phosphorylcholine (PC)-based polymer, a metal-organic framework (MOF) film, or a graphene oxide (GO) functionalized surface. In an embodiment, the bio-inspired hydrophilic coating includes a phosphorylcholine (PC)-based polymer, which is applied through the following steps:

Phosphorylcholine (PC)-based polymers are chemically grafted onto the substrate surface to mimic the water-retention properties of cell membranes.

Phosphorylcholine (PC)-based polymers has the ability to structure water which aids EZ extension, thereby improving surface hydrophilicity.

In another embodiment, the bio-inspired coating with hydrogel networks includes super hydrophilic metal-organic frameworks (MOFs) with functional ligands. The coating process includes the following steps

A Metal-organic frameworks (MOF) film is grown (e.g., ZIF-8, MIL-101) on the substrate surface with hydrophilic ligands such as carboxylates or sulfonates.

High porosity and functional groups facilitate stable exclusion zones, thereby improving hydrophilicity.

In one more embodiment, the bio-inspired coating with hydrogel networks includes graphene oxide (GO) super hydrophilic functionalization, which is applied through the following steps of:

A thin layer of graphene oxide (GO) is deposited and chemically modified with hydrophilic functional groups such as carboxyl (—COOH) and hydroxyl (—OH) through an oxidation process.

High surface energy and charge distribution of the graphene oxide facilitates exclusion zone (EZ) expansion thereby improving water structuring properties.

In addition to above mentioned coating method, the hydrophilic surface may be formed by using the following coating methods.

In an embodiment, 3-Aminopropyltriethoxysilane (APTES) Coating is applied through the following steps.

The substrate is cleaned with piranha solution and rinse with deionized water.

The substrate is immersed in a 1-2% APTES solution in ethanol for 30-60 minutes.

The coated substrate is baked at 110° C. for 1 hour to ensure silane bonding for curing.

In another embodiment, the Aculon hydrophilic coating is applied through the following steps:

Aculon hydrophilic coatings are synthesized. A dip coating or spray coating method is used for uniform deposition using Low-Pressure Chemical Vapor Deposition (LPCVD) or a Physical Vapor Deposition (PVD) process.

In one more embodiment, An Atomic Layer Deposition (ALD) of Zirconia (ZrO₂) with Oxygen-Rich Termination is performed as follows:

Atomic layer deposition (ALD) process is used to deposit a thin film of ZrO₂, followed by post-deposition oxidation to increase hydroxyl (—OH) group density.

The high surface energy of ZrO₂ enhances structured water formation, supporting wide EZs, thereby providing expected effect.

In yet another embodiment, Plasma-enhanced chemical vapor deposition (PECVD) of super hydrophilic diamond-like carbon (DLC) is conducted as follows:

Plasma-enhanced chemical vapor deposition (PECVD) is used to deposit hydrophilic DLC with oxygen-containing functional groups (e.g., carboxyl, hydroxyl).

High wettability due to oxygen bonding strengthens EZ stability, thereby providing expected effect.

In further embodiment, the electrospun nanofiber mats with super hydrophilic polymers are applied through the following steps:

Electrospinning is used to coat the substrate with nanofiber mats, which is made of polyacrylamide or poly(2-hydroxyethyl methacrylate) (PHEMA).

The nanofiber networks create continuous wetting and structured water layers, enhancing exclusion zone (EZ) formation to get the expected effect.

In one more embodiment, a Layered barium strontium titanate (BST) dielectric coating is applied as follows:

Barium strontium titanate (BST) thin films are deposited with a high dielectric constant and surface hydroxylation

Enhanced surface charge promotes water ordering and EZ growth to get the expected effect.

In further embodiment, a functionalized carbon nanotube (CNT) arrays with hydrophilic end groups are applied through the following steps:

Vertically aligned CNTs are grown on the substrate and functionalized with carboxyl or sulfonic acid groups.

Nanochannels in the carbon nanotube (CNTs) facilitate water structuring and enhance EZ formation, thereby achieving the desired effect.

In another embodiment, a hierarchical micropillar arrays with hydrophilic polymer brushes are fabricated as follows:

A micro/nanopillar arrays are created using lithography and coated with hydrophilic polymer brushes (e.g., zwitterionic polymers).

The increased surface area and hydration capacity results in extended exclusion zones.

In yet another embodiment, a bio-templated Silica Deposition Using Hydrophilic Peptides is performed as follows:

Self-assembled peptide scaffolds is used to guide the deposition of hydrophilic silica nanostructures.

The hydrophilic peptides promote strong water adhesion and structured layers to get the expected effect.

In one more embodiment, a plasma-induced hydroxylation & UV Activation is performed as follows:

Oxygen or hydrogen plasma treatment is used to create hydroxyl (—OH) functional groups on the surface, followed by UV irradiation to further enhance hydrophilicity which enhances water structuring via strong hydrogen bonding, increasing the exclusion zone (EZ) width.

In yet another embodiment, a silica nano-structuring with layer-by-layer (LbL) deposition is applied as follows:

Alternating layers of silica nanoparticles and polyelectrolytes (e.g., polydiallyldimethylammonium chloride & silica colloids) are applied to build a highly porous, hydrophilic film to get the high surface roughness and porosity that enhance water adsorption and extend EZ formation.

In further one embodiment, a functionalized silane self-assembled monolayers (SAMs) are formed as follows. Ultra-hydrophilic silanes (e.g., 3-aminopropyltriethoxysilane or perfluorosulfonic acid silanes) are grafted onto the glass/silicon surface.

The strong hydrophilic interactions stabilize the exclusion zone formation.

In one another embodiment, an electrochemical anodization of silicon for nanostructured oxide formation is performed as follows:

Silicon is electrochemically anodized in an HF/H₂O₂ solution. This solution is prepared to create a nanostructured oxide layer with tuneable porosity, thereby providing strong hydrophilic sites with increased EZ stability.

In furthermore embodiment, a photocatalytic titanium dioxide (TiO₂) Coating is applied through the following steps:

A TiO₂ thin film is deposited using atomic layer deposition (ALD) or sol-gel synthesis, then UV-activated to generate a permanently superhydrophilic surface.

Photocatalytic oxidation maintains a fresh layer of hydrophilic functional groups, sustaining EZ formation to achieve the expected effect.

In yet another embodiment, a layered hybrid perovskite/hydrophilic oxide interfaces are formed as follows:

The substrate surface is coated with hydrophilic perovskites (e.g., BaTiO₃ or CaTiO₃) combined with a hydrophilic oxide layer (e.g., SiO₂ or SnO₂) to accumulate the charge at the interface which enhances water ordering, increasing EZ size.

The selection and application of these hydrophilic coatings contribute to the formation of structured water regions within the purification chamber (103). These coatings facilitate the establishment of exclusion zones (EZs) along the inner surfaces of the purification chamber (103), promoting passive water conduction.

In the present embodiment, the first chamber wall (118) includes a first substrate (120) and a first hydrophilic surface (108). The second chamber wall (119) includes a second substrate (161) and a second hydrophilic surface (109). Also, the second chamber wall (119) includes a first major face (123) and a second major face (124) on an opposite side of the second substrate (161) than the first major face (123) (as shown in FIG. 4). Specifically, the substrates are to provide structure for the chamber walls and a surface to establish the hydrophilic surface. In the present embodiment, the first substrate (120) is made of glass. It is obvious to a person skilled in the art to configure the first substrate of any material.

Further, the hydrophilic surfaces contribute to forming the first purified zone (110), the second purified zone (111), and the impure zone (112). The purpose of the hydrophilic surface to draw substantially pure water towards the hydrophilic surface and to exclude impurities in the water away. Specifically, the first hydrophilic surface (108) establishes the first purified zone (110) of substantially pure water from input water stream (160) proximate to the first hydrophilic surface (108). The second hydrophilic surface (109) establishes the second purified zone (111) of substantially pure water from input water stream (160) proximate to the second hydrophilic surface (109). The first hydrophilic surface (108) and the second hydrophilic surface (109) is configured to establish the impure zone (112) between the first purified zone (110) and second purified zone (111) (as shown in FIG. 4).

Additionally, the first hydrophilic surface (108) is bonded to the first substrate (120) of the first chamber wall (118) and the second hydrophilic surface (109) is bonded to the second substrate (161) of the second chamber wall (119). The second hydrophilic surface (109) is spaced from the first hydrophilic surface (108). Also, the second hydrophilic surface (109) is disposed on the first major face (123) of the second chamber wall (119). A third hydrophilic surface (125) is disposed on the second major face (124) of the second chamber wall (119). The second major face (124) and the third hydrophilic surface (125) face into adjacent purification chamber (122) (as shown in FIG. 4).

Furthermore, the purified water outlet (106) is fluidly coupled to the purified water stream (104) exiting the purification module (102) through the purified outlet wall (113). In the present embodiment, the purified outlet wall (113) is coated with the same hydrophilic material as the hydrophilic surface in the purification chamber (103) to ensure continuous hydrophilic interaction along the water conduction pathway. It is obvious to a person skilled in the art to configure the outlets of any geometry (shape and size). Also, the impure water outlet (107) is fluidly coupled to impure water stream (105) exiting the purification module (102) through the impure water outlet wall (116) (as shown in the FIGS. 1 and 2). It is obvious to a person skilled in the art to configure number of inlets and outlets as per the requirement.

Specifically, a first port (114) extends through purified water outlet wall (113) and is disposed proximate to the first hydrophilic surface (108) (as shown in FIGS. 3 and 4). A second port (115) extends through the purified outlet wall (113) and is disposed proximate to the second hydrophilic surface (109) (as shown in FIGS. 3 and 4). A third port (117) extends through the impure outlet wall (116) distal to the first hydrophilic surface (108) and the second hydrophilic surface (109). The first port (114) is disposed in the first purified zone (110) and the second port (115) is disposed in second purified zone (111). The third port (117) is disposed in impure zone (112).

The purified water outlet (106) is fluidly coupled to the purified water stream (104) exiting the purification module (102) through the purified outlet wall (113). In the present embodiment, the purified outlet wall (113) is coated with the same hydrophilic material as the hydrophilic surfaces of the purification chamber (103). The matching hydrophilic treatment ensures continuous hydrophilic interaction along the water conduction pathway, thereby enhancing passive flow of the purified water. It is obvious to a person skilled in the art that the number, shape, and orientation of outlets may vary as required.

Referring now to FIG. 9, in an alternate embodiment, the system (100) includes a chamber wall (218) having a substrate (220). In an example, the substrate (220) is either made of silicon or glass. It is obvious to a person skilled in the art to use any other material suitable for hydrophilic coatings but not limited to silicon or glass. The hydrophilic surface (208) is formed on substrate (220) by autoclaving substrate (220). The autoclaving process makes the surface of substrate (92) significantly more hydrophilic.

Thus, the present invention has an advantage of providing a water purification system (100). The system (100) has reduced green-house gas emissions. The system (100) is easy to maintain. Further, the system (100) is cost effective. Furthermore, the system (100) is simple in operation.

The foregoing descriptions of specific embodiments of the present invention have been presented for purposes of illustration and description. They are not intended to be exhaustive or to limit the present invention to the precise forms disclosed, and obviously, many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

I claim:

1. A water purification system (100), comprising:
an inlet chamber (101) configured to receive an input water stream (160);
a purification module (102) fluidly coupled to the inlet chamber (101), the purification module (102) including a purification chamber (103) configured to divide the input water stream (160) into a purified water stream (104) and an impure water stream (105);
a purified water outlet (106) fluidly coupled to the purified water stream (104);
an impure water outlet (107) fluidly coupled to the impure water stream (105); and
at least one hydrophilic surface disposed within the purification chamber (103), the hydrophilic surface cooperating with a purified outlet wall (113) defining a plurality of micro-capillaries (90), wherein:
each micro-capillary (90) has a non-circular cross-sectional geometry, selected from the group consisting of triangular, trapezoidal, hexagonal, rectangular, rhomboidal, or curved geometries with a smaller cross-section at the bottom than at the top; and
the hydrophilic surface (60) and micro-capillaries (90) are configured to facilitate passive water conduction without requiring applied external pressure.

2. The water purification system (100) as claimed in claim 1, wherein the hydrophilic surface is formed using a material selected from the group consisting of:
a silicon-based hydrophilic coatings,
a metal oxide coating,
a polymer-based hydrophilic layers,
a bio-inspired coatings, or
an atomic layer deposition (ALD) coating.

3. The water purification system (100) as claimed in claim 2, wherein the silicon-based hydrophilic coating includes at least one of:
a starch-coated silicon surface,
a mica-coated silicon surface,
a silica (SiO₂) nano-structured coating, or
a silicon hydroxylation treatment.

4. The water purification system (100) as claimed in claim 2, wherein the metal oxide coating includes at least one of:
a titanium dioxide (TiO₂) coating,
an indium tin oxide (ITO) coating, or
an electrochemically anodized oxide layer.

5. The water purification system (100) as claimed in claim 2, wherein the polymer-based hydrophilic layer includes at least one of:
a polyvinyl alcohol (PVA) coating,
a polyethylene glycol (PEG) coating, or
a polydopamine (PDA) coating.

6. The water purification system (100) as claimed in claim 2, wherein the bio-inspired hydrophilic coating includes at least one of:
a phosphorylcholine (PC)-based polymer,
a metal-organic framework (MOF) film, or
a graphene oxide (GO) functionalized surface.

7. The water purification system (100) as claimed in claim 1, wherein the purification module (20) is manufactured using a process selected from the group consisting of:
3D printing,
injection molding,
anodic bonding of pre-formed glass structures, or
microelectronic adhesive bonding.

8. The water purification system as claimed in claim 1, wherein the purified outlet wall (113) is coated with the same hydrophilic material as the hydrophilic surface of the purification chamber (103) to ensure continuous hydrophilic interaction along the water conduction pathway.

9. The water purification system as claimed in claim 1, wherein the purified outlet wall (113) and the impure outlet wall (116) are placed parallel to each other and have vertical striations (70) to allow the hydrophilic surfaces to slide in, wherein the vertical striations (70) on the purified outlet wall (113) and the impure outlet wall (116) are configured in such a way that the hydrophilic surfaces are parallel to each other after sliding therein.

10. The water purification system as claimed in claim 9, wherein the vertical striations (70) are etched at equal distances to keep the volume of each purification chamber (103) constant or maybe etched at different distances if variation in volume is required across each purification chamber (103).

11. The water purification system as claimed in claim 10, wherein the microcapillaries are created by a wet etching process with an increasing cross-section and facilitating unidirectional flow of purified water in the direction of increasing cross-section thereby further enhancing the efficacy of water conduction in tandem with a non-circular cross-sectional geometry.
